(19) United States
(12) Patent Application Publication
(10) Pub. No.: US 2015/0377406 A1
(43) Pub. Date: Dec. 31, 2015

(54) INSULATING ELEMENT

(71) Applicant: ROCKWOOL INTERNATIONAL A/S, Hedehusene (DK)

(72) Inventors: Dorte Bartnik Johansson, Roskilde (DK); Peter Farkas Binderup HANSEN, Birkerod (DK); Gorm ROSENBERG, Gadstrup (DK)

(21) Appl. No.: 14/767,143

(22) PCT Filed: Feb. 18, 2014
(86) PCT No.: PCT/EP2014/053152

§ 371 Date: Aug. 11, 2015

(30) Foreign Application Priority Data
Feb. 18, 2013 (EP) 13155691.2

(51) Int. Cl. F16L 59/02; F16L 59/14; B32B 5/18

(52) U.S. Cl. CPC F16L 59/024; F16L 59/029; B32B 5/18; F16L 59/145; B32B 2266/0278; B32B 2307/304; B32B 2597/00; B32B 2262/108

(57) ABSTRACT

The invention provides an insulating element (1) for insulating a pipe, comprising: a partial pipe section (2) having an external convex face (3), an internal concave face (4) and first (5) and second (6) longitudinal surfaces extending between the external convex face (3) and the internal concave face (4), the partial pipe section (2) being formed of a polymeric foam composite material comprising a polymeric foam and discontinuous man-made vitreous fibres, wherein at least 50% by weight of the man-made vitreous fibres present in the foam composite material have a length of less than 100 micrometers.

### FIELD OF THE INVENTION

The invention relates to an insulating element for insulating a pipe. The invention also relates to a method of insulating a pipe using such an insulating element.

### BACKGROUND OF THE INVENTION

When insulating pipes, there is often a large difference in temperature between the contents of the pipe and the surrounding environment. As a result, it is often important to provide a high level of insulation and to ensure that no gaps exist in the insulation, which could provide a thermal bridge. It is also desirable to have close contact between the pipe and the insulating cover. This prevents convection along and around the pipe, which, in some circumstances, leads to a reduction in the overall level of insulation.

In some circumstances, it can also be important for the pipe to be insulated with a material having a high level of fire resistance, in particular if the material being conveyed in the pipe is flammable. It can also be desirable for the insulating material to provide some physical protection to the pipe to avoid any damage and possible escape of hazardous or flammable materials.

CH 420754 describes an insulating element, which can be semi-tubular. The element can comprise a semi-tubular shell made from expanded plastic material such as expanded polystyrene and a covering layer having a higher heat resistance.

GB 995284 discloses a heat insulating tube of polyurethane foam material having an inner lining of thermally insulating mineral material. The inner layer reduces the heating of the foam material and allows its use as insulating material for pipes which carry a medium which is above the critical temperature of the polyurethane foam.

Whilst polyurethane foam and polystyrene foam can provide a good level of insulation, they are often limited to insulation of pipes up to 100-150° C., where the conventional foam starts to soften and substantial shrinkage tends to appear. Another disadvantage of using these materials as an insulating material for pipes is that they are not sufficiently fire resistant for some applications. In circumstances where the pipe is particularly susceptible to damage, it would also be desirable to provide a more rigid, less easily compressible insulating element. It would also be desirable to achieve these properties without compromising the level of heat insulating that is provided.

In the article “Anwendung zerkleinerter Glasfasern als modifizierender Zusatz für Polyurethanhartschaumstoffe” (Plaste and Kautschuk, vol. 26 no. 1, pg 23-25), the characteristics of polyurethane composites comprising continuous E type AlBSi glass fibres of length less than 0.5 mm are investigated. The composites described in the prior art are generally not aimed at providing an insulating board with the combination of a high fire resistance, high compressive strength and a high compression modulus of elasticity, but with a low density as compared with high-density mineral fibre boards.

### SUMMARY OF THE INVENTION

In order to achieve these objects, the invention provides an insulating element for insulating a pipe, comprising:
a partial pipe section having an external convex face, an internal concave face and first and second longitudinal surfaces extending between the external convex face and the internal concave face, the partial pipe section being formed of a polymeric foam composite material comprising a polymeric foam and discontinuous man-made vitreous fibres, wherein at least 50% by weight of the man-made vitreous fibres present in the foam composite material have a length of less than 100 micrometers.

The invention also provides a method of insulating a pipe, comprising:
providing at least a first insulating element and a second insulating element each according to the invention; and
affixing the first and second insulating elements on the pipe to be insulated such that the first and second insulating elements cooperate so as to surround the pipe completely.

The invention also provides a pipe that is insulated by first and second insulating elements each according to the invention, wherein the first and second insulating elements cooperate so as to surround the pipe completely.

The insulating element of the invention has an excellent combination of properties. The inventors have found that the dimensional stability at high temperatures can be improved with the use of a specific foam composite material. This composite material also has a high level of fire resistance in comparison with conventional foam and a high compressive strength, which allows more effective protection of the pipe being insulated.

It is well-known that conventional polymeric foam shrinks over time and substantial shrinkage occurs, when the foam is exposed to higher temperatures. The particular foam composite material that is used in the invention has also been found to be susceptible to some shrinkage when exposed to high temperatures, but the degree of shrinkage is much smaller than conventional polymeric foams. However, any shrinkage results in a risk that the insulating element leaves a gap between the two insulating elements that cooperate to surround the pipe or between the two insulating elements and the pipe. If parts of the pipe became exposed, that would severely reduce the level of insulation provided. Therefore, in a preferred embodiment there is provided a covering layer comprising coherent man-made vitreous fibre-containing insulating material disposed on the concave face and at least one of the longitudinal surfaces of the partial pipe section. This coherent man-made vitreous fibre-containing insulating material is less rigid than the polymeric foam composite and can expand to fill gaps that might appear over time. Its presence on the internal concave face of the partial pipe section also ensures close contact between the insulating element and the insulated pipe.

### DETAILED DESCRIPTION OF THE INVENTION

The invention is described in more detail below, with reference to the drawings.

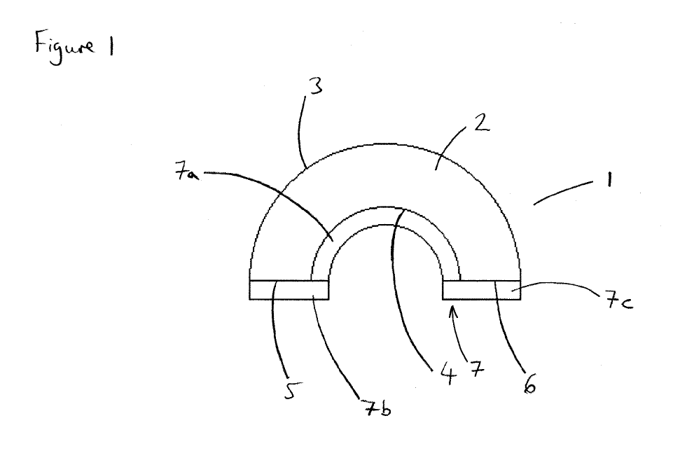

FIG. 1 shows a cross-section of an insulating element according to the invention.

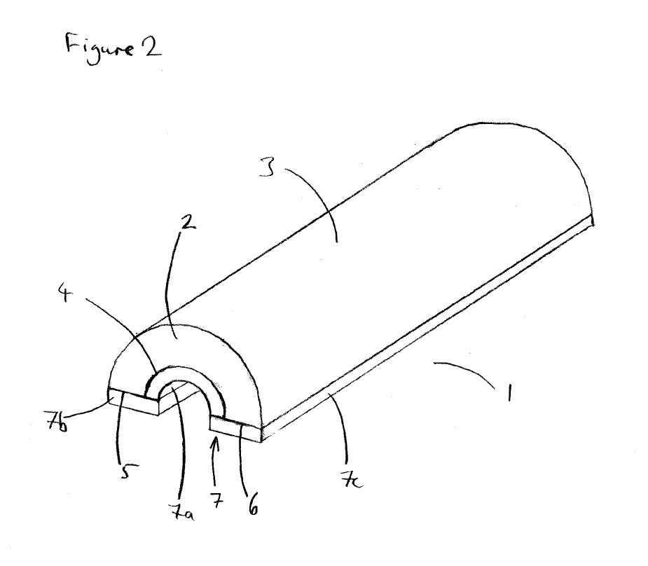

FIG. 2 shows a perspective view of an insulating element according to the invention.

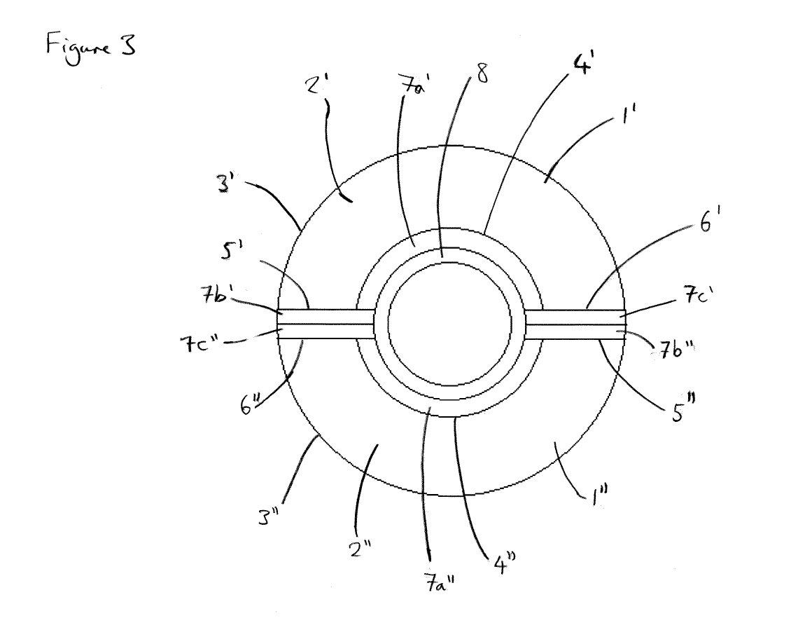

FIG. 3 shows a cross-section of an insulated pipe according to the invention.

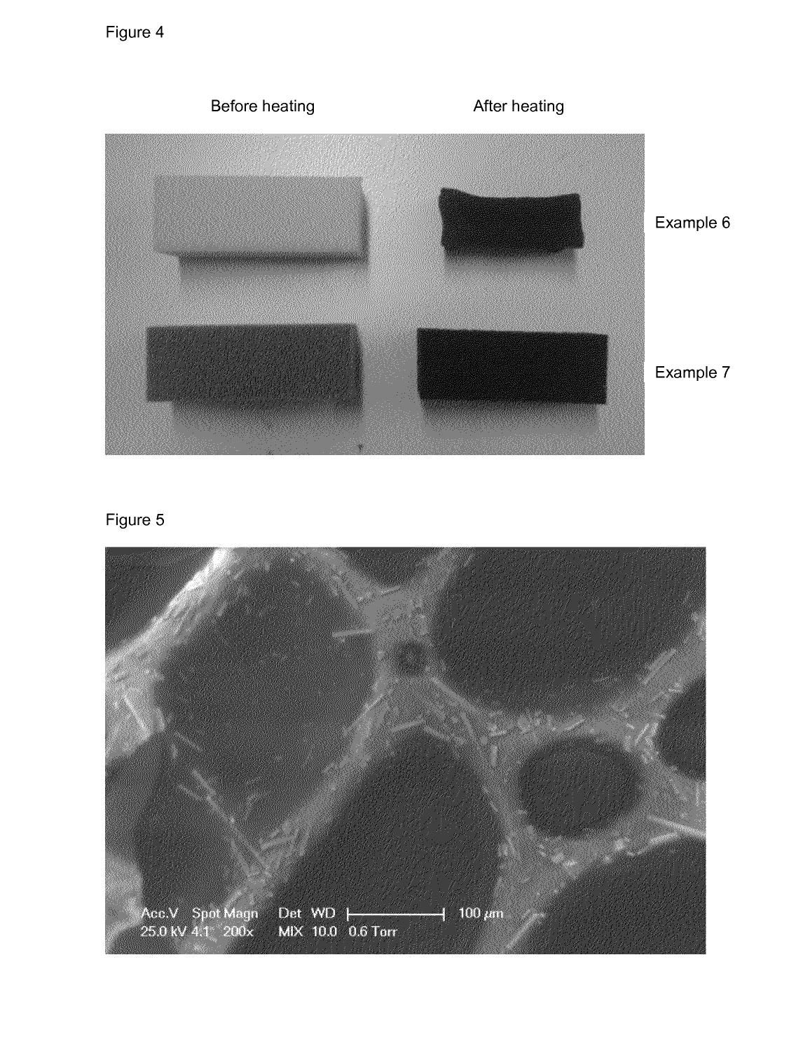

FIG. 4 shows the results of the experiments carried out in Examples 6 and 7.

FIG. 5 shows an environmental scanning electron microscope image of a foam composite usable in the invention.

FIGS. 1 and 2 show an insulating element 1 for insulating a pipe. The insulating element 1 comprises a partial pipe section 2 having an external convex face 3 and an internal concave face 4, a first longitudinal surface 5 extending between the external convex face 3 and the internal concave face 4 and a second longitudinal surface 6 extending between the external convex face 3 and the internal concave face 4. The partial pipe section 2 is formed of a polymeric foam composite material as detailed below.

In the preferred shown embodiment the insulating element 1 also comprises a covering layer 7 comprising a coherent man-made vitreous fibre-containing insulating material as discussed below. The covering layer 7a, 7b is disposed on the internal concave face 4 and at least the first longitudinal surface 5 of the partial pipe section 2. In the embodiment shown in FIGS. 1 and 2, the covering layer 7 also has a part 7c that is disposed on the second longitudinal surface 6 of the partial pipe section 2. This is a preferred embodiment of the invention. It is also possible, however, for the second longitudinal surface 6 of the partial pipe section 2 to be exposed or to have a cover that does not comprise coherent man-made vitreous fibre-containing insulating material.

The insulating element 1 generally has the shape of a partial tube. Preferably, regardless of whether a covering layer 7 is present, the insulating element is essentially semi-tubular as shown in FIGS. 1 and 2, so that two insulating elements 1 according to the invention can cooperate to form a complete tube that surrounds a pipe. It is also possible, however, for the insulating element 1 to form greater than or less than half of a complete tube if desired. To ensure that the insulating element 1 can be positioned easily on a pipe, it cannot be a complete tube, however.

Similarly, the partial pipe section 2 is preferably essentially semi-tubular as shown in FIGS. 1 and 2, which allows two insulating elements 1 according to the invention to cooperate to form a complete tube that surround a pipe. In order to ensure a high level of protection for the pipe and a high level of thermal insulation, the partial pipe section 2 formed of the polymeric foam composite material usually contributes the majority of the thickness of the insulating element. The precise thickness varies depending on the circumstances, but usually the thickness of the partial pipe section 2 from its internal concave face 4 to its external convex face 3 is from 8 mm to 200 mm, more usually from 10 mm to 120 mm and most usually from 12 mm to 80 mm. These preferred features of the partial pipe section are, of course, applicable regardless of whether the covering layer 7 is present.

The covering layer 7 is generally selected to be sufficiently thick in its uncompressed state to allow it to expand to fill gaps in the insulation in case of shrinkage of the partial pipe section 2. Usually, the covering layer has a thickness at its thickest point in the range 5 mm to 40 mm, more usually from 7 mm to 30 mm, most usually from 10 mm to 20 mm. In most cases, the thickness of the covering layer—when present—is less than half the thickness of the partial pipe section formed of polymeric foam composite material. The thickness of the covering layer 7 can be uniform or it can vary so that some parts are thicker than others. For example the part 7a of the covering layer 7 disposed on the internal concave face 5 could be thinner than the parts 7b, 7c of the covering layer 7 disposed on the first and second longitudinal surfaces 5, 6 of the partial pipe section 2. This would allow for a greater degree of shrinkage of the partial pipe section 2 in its circumferential dimension than in its radial dimension.

In the embodiment shown in FIGS. 1 and 2, the covering layer is formed of three separate parts 7a, 7b, 7c. A first part 7a covers the internal concave face 4 of the partial pipe section 2. The second and third parts of the covering layer 7b, 7c cover the first and second longitudinal surfaces 5, 6 of the partial pipe section 2 respectively. In an alternative embodiment, however, the covering layer 7 is formed from a single piece of coherent man-made vitreous fibre-containing insulating material. Of course, the invention also relates to insulating elements 1 in which the second longitudinal surface 6 is not covered and the covering layer 7 only covers the internal concave face 4 and the first longitudinal surface 5. In that case, the covering layer could be formed of two separate parts 7a, 7b or a single piece of coherent man-made vitreous fibre-containing insulating material.

The covering layer 7 can be affixed to the partial pipe section 2 with the use of an adhesive. Alternatively, the covering layer 7 can be bonded to the partial pipe section 2 without any extrinsic attachment means. This can be achieved by forming the polymeric foam composite material with the covering layer 7 in place. This results in an intrinsic bond between the partial pipe section 2 and the covering layer 7.

It is preferred, as shown in FIGS. 1 and 2, for the covering layer 7 to be affixed to the partial pipe section 2 directly. However, it is also within the scope of the invention for there to be an intermediate layer (not shown) between the partial pipe section 2 and the covering layer 7. This could be an adhesive strip, for example.

In one embodiment, as shown in FIGS. 1 and 2, the first and second longitudinal surfaces 5, 6 are planar and the parts of the covering layer 7b, 7c disposed on the first longitudinal surface 5 and, where present, on the second longitudinal surface 6 are also planar. This allows two insulating elements 1 to cooperate to form a tube by simply pressing them against one another. In an alternative embodiment, the first and second longitudinal surfaces 5, 6 of the partial pipe section 2 are stepped. Preferably, in this embodiment, the part of the covering layer 7b disposed on the first longitudinal surface 5 is correspondingly stepped and, where present, the part of the covering layer 7c disposed on the second longitudinal surface 6 is also correspondingly stepped.

In embodiments where the covering layer 7 is not present, the first and second longitudinal surfaces 5, 6 can also be either planar or stepped.

The insulating element 1 can consist essentially of the partial pipe section 2 and, optionally, the covering layer 7. Alternatively, it can be advantageous to provide a film (not shown) on the external convex surface 3 of the partial pipe section 2. This could, for example, be a metallic film. The provision of such a film can help to protect the partial pipe section 2 and reduce heat transfer by radiation. FIG. 3 shows a pipe 8 that is insulated by first and second insulating elements 1′, 1″ that cooperate so as to surround pipe 8 completely. In the embodiment shown, first and second insulating elements 1′, 1″ each have a covering layer 7′, 7″ that has a part 7c′, 7c″ that is disposed on the second longitudinal surface 6′, 6″ of the partial pipe section 2′, 2″. It is also possible, however, for the covering layers 7′, 7″ only to cover the internal concave face 4′, 4″ and the first longitudinal surface 5′, 5″ of each insulating element 1′, 1″.

Preferably, as shown in FIG. 3, the part of the covering layer 7b′ disposed on the first longitudinal surface 5′ of the first insulating element 1′ abuts the second insulating element 1″. Similarly, the part of the covering layer 7b″ disposed on the first longitudinal surface 5″ of the second insulating element 1″ abuts the first insulating element 1′, so as to surround the pipe completely. This is also preferred in embodiments where the covering layers 7′, 7″ only cover the internal concave face 4′, 4″ and the first longitudinal surface 5′, 5″ of each insulating element 1′, 1″.

In one embodiment the parts 7b′, 7c′ of the covering layer 7′ disposed on the first and second longitudinal surfaces 5′, 6′ of the first insulating element 1′ each abut a part 7b″, 7c″ of the covering layer 7″ disposed on the first or second longitudinal surfaces 5″, 6″ of the second insulating element 1″. In this embodiment the covering layers 7′, 7″ cooperate most effectively to compensate for any shrinkage in the partial pipe sections 2′, 2″.

There is no particular limitation on how the insulating elements 1′, 1″ can be affixed onto the pipe 8. Possible methods include gluing the insulating elements 1′, 1″ to each other, attaching the insulating elements 1′, 1″ with straps (not shown) that are preferably elastic, or a combination of both. When the insulating elements 1′, 1″ are glued to each other, this further contributes to the prevention of gaps appearing in the insulation, if the partial pipe sections 2′, 2″ were to shrink slightly. Another solution is to glue a common foil, e.g. an aluminium foil, to the outer convex surfaces 3′, 3″ of two adjacent insulating elements 1′, 1″. The foil would be open at one of the longitudinal surfaces, whereas it could act as a hinge at the other longitudinal surfaces allowing such interconnected two insulating elements 1′,1″ to be arranged on a pipe 8.

Polymeric Foam Composite Material

The invention makes use of the polymeric foam composite material described in our earlier application filed on 18 Aug. 2011 and having the application number EP 11177971.6 and in our international application PCT/EP2012/066196 filed on 20 Aug. 2012. The disclosure of those applications is incorporated herein by reference.

The polymeric foam composite material used in the present invention can be produced from a foamable composition comprising a foam pre-cursor and discontinuous man-made vitreous fibres, wherein at least 50% by weight of the man-made vitreous fibres have a length of less than 100 micrometres.

The term “discontinuous man-made vitreous fibres” is well understood by those skilled in the art. Discontinuous man-made vitreous fibres are, for example, those produced by internal or external centrifugation, for example with a cascade spinner or a spinning cup.

The weight percentage of fibres in the polymeric foam composite material or in the foamable composition above or below a given fibre length is measured with a sieving method. A representative sample of the man-made vitreous fibres is placed on a wire mesh screen of a suitable mesh size (the mesh size being the length and width of a square mesh) in a vibrating apparatus. The mesh size can be tested with a scanning electron microscope according to DIN ISO3310. The upper end of the apparatus is sealed with a lid and vibration is carried out until essentially no further fibres fall through the mesh (approximately 30 mins). If the percentage of fibres above and below a number of different lengths needs to be established, it is possible to place several screens with incrementally increasing mesh sizes on top of one another. The fibres remaining on each screen are then weighed.

In order to measure the length of fibres present in a polymeric foam composite of the invention, it is possible to burn off the foam from a representative sample of the foam composite by placing it in a 590° C. furnace for 20 min. This method is according to ASTM C612-93. The remaining fibres can then be analysed using a wire mesh screen as set out above.

According to the invention, the man-made vitreous fibres present in the polymeric foam composite must have at least 50% by weight of the fibres with a length less than 100 micrometres as measured by the method above.

By reducing the length of man-made vitreous fibres that are present in the foamable composition and in the polymeric foam composite, a larger quantity of fibres can be included in the foamable composition before an unacceptably high viscosity is reached. As a result, the compressive strength, fire resistance, and in particular the compression modulus of elasticity and the thermal dimensional stability of the resulting foam can be improved. Previously, it had been thought that ground fibres having such a low length would simply act as a filler, increasing the density of the foam. However, by using mineral fibres with such a high proportion of short fibres, far higher levels of fibres can be incorporated into the foam precursor and the resulting foam. The result of this is that significant increases in the compressive strength and, in particular, the compression modulus of elasticity of the foam can be achieved. The dimensional stability at higher temperatures is also significantly increased.

Preferably, the length distribution of the man-made vitreous fibres present in the polymeric foam composite or foamable composition is such that at least 50% by weight of the man-made vitreous fibres have a length of less than 75 micrometres, more preferably less than 65 micrometres.

Preferably, at least 60% by weight of the man-made vitreous fibres present in the polymeric foam composite or foamable composition have a length less than 100 micrometres, more preferably less than 75 micrometres and most preferably less than 65 micrometres.

Generally, the presence of longer man-made vitreous fibres in the polymeric foam composite or foamable composition is found to be a disadvantage in terms of the viscosity of the foamable composition and the ease of mixing. Therefore, it is preferred that at least 80%, or even 85 or 90% of the man-made vitreous fibres present in the polymeric foam composite or foamable composition have a length less than 125 micrometres. Similarly, it is preferred that at least 95%, more preferably at least 97% or 99% by weight of the man-made vitreous fibres present in the polymeric foam composite or foamable composition have a length less than 250 micrometres.

The greatest compressive strength and highest dimensional stability can be achieved when at least 90% by weight of the fibres have a length less than 100 micrometres and at least 75% of the fibres by weight have a length less than 65 micrometres.

Man-made vitreous fibres having the length distribution discussed above have been found generally to sit within the walls of the cells of the foam composite, without penetrating the cells to a significant extent. Therefore, it is believed that a greater percentage by weight of the fibres in the composite contribute to increasing the strength of the composite rather than merely increasing its density.

It is also preferred that at least some of the fibres present in the foam composite material, for example at least 0.5% or at least 1% by weight, have a length less than 10 micrometres. These very short fibres are thought to be able to act as nucleating agents in the foam formation process. The action of very short fibres as nucleating agents can favour the production of a foam with numerous small cells rather than fewer large cells.

The fibres present in the polymeric foam composite or in the foamable composition can be any type of discontinuous man-made vitreous fibres, but are preferably stone fibres. In general, stone fibres have a content by weight of oxides as follows:
SiO₂ 25 to 50%, preferably 38 to 48%
Al₂O₃ 12 to 30%, preferably 15 to 28%
TiO2 up to 2%
Fe₂O₃ 2 to 12%
CaO 5 to 30%, preferably 5 to 18%
MgO up to 15% preferably 4 to 10%
Na₂O up to 15%
K₂O up to 15%
P₂O₅ up to 3%
MnO up to 3%
B₂O₃ up to 3%.

These values are all quoted as oxides, with iron expressed as Fe₂O₃, as is conventional.

An advantage of using fibres of this composition in the polymeric foam composite material, especially in the context of polyurethane foams, is that the significant level of iron and alumina in the fibres can act as a catalyst in formation of the foam. This effect is particularly relevant when at least some of the iron in the fibres is present as ferric iron, as is usual and/or when the level of Al₂O₃ is particularly high such as 15 to 28% or 18 to 23%.

An alternative stone wool composition useful in the invention has oxide contents by weight in the following ranges:
SiO₂ 37 to 42%
Al₂O₃ 18 to 23%
CaO+MgO 34 to 39%
Fe₂O₃ up to 1%
Na₂O+K₂O up to 3%

Again, the high level of alumina in fibres of this composition can act as a catalyst in the formation of a polyurethane foam. Whilst stone fibres are preferred, the use of discontinuous glass fibres or slag fibres is also possible.

The man-made vitreous fibres present in the polymeric foam composite and foamable composition are discontinuous man-made vitreous fibres. The term “discontinuous man-made vitreous fibres” is well understood by those skilled in the art. Discontinuous man-made vitreous fibres are, for example, those produced by internal or external centrifugation, for example with a cascade spinner or a spinning cup. Traditionally, fibres produced by these methods have been used for insulation, whilst continuous glass fibres have been used for reinforcement in composites. Continuous fibres (e.g. continuous E glass fibres) are known to be stronger than discontinuous fibres produced by cascade spinning or with a spinning cup (see “Impact of Drawing Stress on the Tensile Strength of Oxide Glass Fibres”, J. Am. Ceram. Soc., 93 [10] 3236-3243 (2010)). Nevertheless, it has been found that foam composites comprising short, discontinuous fibres have a compressive strength that is at least comparable with foam composites comprising continuous glass fibres of a similar length. This unexpected level of strength is combined with good fire resistance, a high level of thermal insulation and cost efficient production.

In order to achieve the required length distribution of the fibres, it will usually be necessary for the fibres to be processed further after production. The further processing will usually involve grinding or milling of the fibres for a sufficient time for the required length distribution to be achieved.

Usually, the fibres present in the polymeric foam composite and foamable composition have an average diameter of from 1.5 to 7 micrometres. Preferably, the fibres have an average diameter of from 2 to 6 micrometres, more preferably the fibres have an average diameter of from 3 to 6 micrometres. Thin fibres as preferred in the invention are believed to provide a higher level of thermal insulation to the composite than thicker fibres, but without a significant reduction in strength as compared with thicker fibres as might be expected. The average fibre diameter is determined for a representative sample by measuring the diameter of at least 200 individual fibres by means of the intercept method and scanning electron microscope or optical microscope (1000× magnification).

The foamable composition that can be used to produce the polymeric foam composite comprises a foam precursor and man-made vitreous fibres. The foam precursor is a material that either polymerises (often with another material) to form a polymeric foam or is a polymer that can be expanded with a blowing agent to form a polymeric foam. The composition can be any composition capable of producing a foam on addition of a further component or upon a further processing step being carried out.

Preferred foamable compositions are those capable of producing polyurethane foams. Polyurethane foams are produced by the reaction of the polyol with an isocyanate in the presence of a blowing agent. Therefore, in one embodiment, the foamable composition comprises, in addition to the man-made vitreous fibres, a polyol as the foam precursor. In another embodiment, the foamable composition comprises, in addition to the man-made vitreous fibres, an isocyanate as the foam precursor. In another embodiment, the composition comprises a mixture of an isocyanate and a polyol as the foam precursor.

If the foam precursor is a polyol, then foaming can be induced by adding a further component comprising an isocyanate. If the foam precursor is an isocyanate, foam formation can be induced by the addition of a further component comprising a polyol.

Suitable polyols for use either as the foam precursor or to be added as a further component to the foamable composition to induce foam formation are commercially available polyol mixtures from, for example, Bayer Material Science, BASF or DOW Chemicals. Commercially available polyol compositions are often supplied as a pre-mixed component that comprises polyol and any or all of catalyst(s), flame retardant(s), surfactants and water, which can act as a chemical blowing agent in the foam formation process. Generally it comprises all of these. Such a pre-formed blend of polyol with additives is commonly known as a pre-polyol.

The isocyanate for use either as the foam precursor or to be added as a further component to the foamable composition to induce foam formation is selected on the basis of the density and strength required in the foam composite as well as on the basis of toxicity. It can, for example, be selected from methylene polymethylene polyphenol isocyanates (PMDI), methylene diphenyl diisocyanate (MDI), toluene diisocyanate (TDI), hexamethylene diisocyanate (HDI) and isophorone diisocyanate (IPDI), PMDI or MDI being preferred. One particularly suitable example is diphenylmethane-4,4′-diisocyanate. Other suitable isocyanates are commercially available from, for example, Bayer Material Science, BASF or DOW Chemicals.

In order to form a foam composite, a blowing agent is required. The blowing agent can be a chemical blowing agent or a physical blowing agent. In some embodiments, the foamable composition comprises a blowing agent. Alternatively, the blowing agent can be added to the foamable composition together with a further component that induces foam formation.

In the context of polyurethane foam composites, in a preferred embodiment, the blowing agent is water. Water acts as a chemical blowing agent, reacting with the isocyanate to form CO₂, which acts as the blowing gas.

When the foam-precursor is a polyol, in one embodiment, the foamable composition comprises water as a blowing agent. The water is usually present in such a foamable composition in an amount from 0.3 to 2% by weight of the foamable composition.

As an alternative, or in addition, a physical blowing agent, such as liquid CO₂ or liquid nitrogen could be included in the foamable composition or added to the foamable composition as part of the further component that induces foam formation.

The foamable composition, in an alternative embodiment, is suitable for forming a phenolic foam. Phenolic foams are formed by a reaction between a phenol and an aldehyde in the presence of an acid or a base. A surfactant and a blowing agent are generally also present to form the foam. Therefore, the foamable composition could comprise, in addition to the man-made vitreous fibres, a phenol and an aldehyde (the foam precursor), a blowing agent and a surfactant. Alternatively, the foamable composition could comprise as the foam precursor, a phenol but no aldehyde, or an aldehyde but no phenol.

Whilst foamable compositions suitable for forming polyurethane or phenolic foams are preferred, it is also possible to use foamable compositions suitable for forming polyisocyanurate, expanded polystyrene and extruded polystyrene foams.

In an alternative embodiment, the polyurethane foam composite is especially a polyisocyanurate foam composite, where the blowing agent is preferably pentane. Pentane has the advantage over other blowing agents that it is more environmentally friendly and cost effective than for instance HFC blowing agents. Pentane can be c-pentane, i-pentane, or n-pentane or a mixture of two or more of these. The choice between c-pentane, i-pentane and n-pentane is dependent on the production method. They are quite different in boiling point, initial thermal conductivity, aged thermal conductivity and price. The preferred pentane in this invention is n-pentane based on the price and aged thermal conductivity.

The foamable composition that can be used to make the foam composite used in the invention can contain additives in addition to the foam precursor and the man-made vitreous fibres. When it is desired to include additives in the foam composite, as an alternative to including the additives in the foamable composition comprising man-made vitreous fibres, the additive can be included with a further component that is added to the foamable composition to induce foam formation.

As an additive, it is possible for the composition or the foam composite to comprise a fire retardant such as expandable powdered graphite, aluminium trihydrate or magnesium hydroxide. The amount of fire retardant in the composition is preferably from 3 to 20% by weight, more preferably from 5 to 15% by weight and most preferably from 8 to 12% by weight. The total quantity of fire retardant present in the polymeric foam composite material is preferably from 1 to 10%, more preferably from 2 to 8% and most preferably from 3 to 7% by weight.

Alternatively, or in addition, the foamable composition or foam composite can comprise a flame retardant such as nitrogen- or phosphorus-containing polymers.

The fibres used in the polymeric foam composite can be treated with binder, which, as a result, can be included in the composition and the resulting foam composite as an additive if it is chemically compatible with the composition. The fibres used usually contain less than 10% binder based on the weight of the fibres and binder. The binder is usually present in the foamable composition at a level less than 5% based on the total weight of the foamable composition. The foam composite usually contains less than 5% binder, more usually less than 2.5% binder. In a preferred embodiment, the man-made vitreous fibres used are not treated with binder.

In some circumstances, it is advantageous, before mixing the man-made vitreous fibres into the foamable composition, to treat the fibres with a surfactant, usually a cationic surfactant. The surfactant could, alternatively, be added to the composition as a separate component. The presence of a surfactant, in particular a cationic surfactant, in the composition and as a result in the polymeric foam composite material has been found to provide easier mixing and, therefore, a more homogeneous distribution of fibres within the foamable composition and the resulting foam.

One advantage of the described polymeric foam composite is that it is possible to incorporate larger percentages of fibres into the foamable composition, and therefore into the resulting foam, than would be the case with longer fibres. This allows higher levels of fire resistance, dimensional stabililty and compressive strength to be achieved. Preferably, the composition comprises at least 15% by weight, more preferably at least 20% by weight, most preferably at least 35% by weight of man-made vitreous fibres. The polymeric foam composite material itself preferably comprises at least 10% by weight, more preferably at least 15% by weight, most preferably at least 20% by weight of man-made vitreous fibres.

Usually the foamable composition comprises less than 85% by weight, preferably less than 80%, more preferably less than 75% by weight man-made vitreous fibres. The resulting foam composite usually contains less than 80% by weight, preferably less than 60%, more preferably less than 55% by weight man-made vitreous fibres.

The polymeric foam composite used in the invention comprises a polymeric foam and man-made vitreous fibres. The foam composite can be formed from the foamable composition as described above. It is preferred that the polymeric foam is a polyurethane foam or a phenolic foam. Polyurethane foams are most preferred due to their low curing time.

The first step in the production of the polymeric foam composite material is to form the foamable composition comprising the foam precursor and the mineral fibres. The fibres can be mixed into the foam precursor by a mechanical mixing method such as use of a rotary mixer or simply by stirring. Additives as discussed above can be added to the foamable composition.

Once the fibres and foam precursor have been mixed, the formation of a foam can then be induced. The manner in which the foam is formed depends on the type of foam to be formed and is known to the person skilled in the art for each type of polymeric foam. In this respect, reference is made to “Handbook of Polymeric Foams and Foam Technology” by Klempner et al.

For example, in the case of a polyurethane foam, the man-made vitreous fibres can be mixed with a polyol as the foam precursor. The foamable composition usually also comprises water as a chemical blowing agent. Then foaming can be induced by the addition of an isocyanate.

In the case where a further component is added to the foamable composition to induce foaming, this can be carried out in a high pressure mixing head as commercially available.

In one embodiment, foam formation is induced by the addition of a further component and the further component comprises further man-made vitreous fibres, wherein at least 50% by weight of the further man-made vitreous fibres have a length of less than 100 micrometres. Including man-made vitreous fibres in both the foamable composition and the further component can increase the overall quantity of fibres in the foam composite, by circumventing the practical limitation on the quantity of fibres that can be included in the foamable composition itself.

For example in the context of polyurethane foam composites a foamable composition could comprise a polyol, man-made vitreous fibres and water. Then foaming could be induced by the addition, as the further component, of a mixture of isocyanate and further man-made vitreous fibres, wherein at least 50% of the man-made vitreous fibres have a length of less than 100 micrometres.

In essentially the same process, the mixture of isocyanate and man-made vitreous fibres could constitute the foamable composition, and the mixture of polyol, water and man-made vitreous fibres could constitute the further component.

The quantity of man-made vitreous fibres in the further component is preferably at least 10% by weight, based on the weight of the further component. More preferably the quantity is at least 20% or at least 30% based on the weight of the further component. Usually, the further component comprises less than 80% by weight, preferably less than 60%, more preferably less than 55% by weight man-made vitreous fibres.

The polymeric foam composite is the material that provides compressive strength and resistance to compression to the thermal insulating element. Therefore, preferably the polymeric foam composite has a compressive strength of at least 1500 kPa and a compression modulus of elasticity of at least 60,000 kPa as measured according to European Standard EN 826:1996.

The following are examples of the polymeric foam composite materials as used in the invention as compared with other polymeric foam composite materials.

### Example 1

### Comparative

100.0 g of a commercially available composition of diphenylmethane-4,4′-diisocyanate and isomers and homologues of higher functionality, and 100.0 g of a commercially available polyol formulation were mixed by propellers for 20 seconds at 3000 rpm. The material was then placed in a mold to foam, which took about 3 min. The following day, the sample was weighed to determine its density and the compression strength and compression modulus of elasticity were measured according to European Standard EN 826:1996.

Compressive strength: 1100 kPa

Compression modulus of elasticity: 32000 kPa

### Example 2

100.0 g of the same commercially available polyol formulation as used in Example 1 was mixed with 200.0 g ground stone wool fibres, over 50% of which have a length less than 64 micrometres, for 10 seconds. Then 100.0 g of the commercially available composition of diphenylmethane-4,4′-diisocyanate was added and the mixture was mixed by propellers for 20 seconds at 3000 rpm. The material was then placed in a mold to foam, which took about 3 min. The following day, the sample was weighed to determine its density and the compression strength and compression modulus of elasticity were measured according to European Standard EN 826:1996.

Compressive strength: 1750 kPa

Compression modulus of elasticity: 95000 kPa

### Example 3

### Comparative

100.0 g of the same commercially available polyol formulation as used in Examples 1 and 2 was mixed for 10 seconds with 50.0 g stone fibres having a different chemical composition from those used in Example 2 and having an average length of 300 micrometres. 100.0 g of the commercially available composition of diphenylmethane-4,4′-diisocyanate was added. The mixture was then mixed by propellers for 20 seconds at 3000 rpm. The material was placed in a mold to foam, which takes about 3 min. The following day, the sample was weighed to determine its density and the compression strength and compression modulus of elasticity were measured according to European Standard EN 826:1996.

Compressive strength: 934 kPa

Compression modulus of elasticity: 45000 kPa

### Example 4

Example 3 was repeated, but the fibres were ground such that greater than 50% of the fibres had a length less than 64 micrometres. Following this grinding it became possible to mix 200 g of the fibres with the polyol mixture.

Compressive strength: 1785 kPa

Compression modulus of elasticity: 115000 kPa.

### Example 5

Small flame tests were carried out according to ISO/DIS 11925-2 to establish the fire resistance of polymeric foam composites as used in the invention compared with the fire resistance of composites comprising quartz sand rather than fibres according to the invention. The foam used was polyurethane foam. The fibres used had a composition within the following ranges.
SiO₂ 38 to 48 wt %
Al₂O₃ 17 to 23 wt %
TiO2 up to 2 wt %
Fe₂O₃ 2 to 12 wt %
CaO 5 to 18 wt %
MgO 4 to 10 wt %
Na₂O up to 15 wt %
K₂O up to 15 wt %
P₂O₅ up to 3 wt %
MnO up to 3 wt %
B₂O₃ up to 3 wt %

The quartz sand used had a particle size up to 2 mm. In each composite tested, expanding graphite was included as a fire retardant. The test involved measuring the height of a flame from each composite under controlled conditions. The results were as follows:

| Fibre Content | Sand Content | Graphite Content | |
|---|---|---|---|
| (wt %) | (wt %) | (wt %) | Flame height (cm) |
| 25 | 0 | 8 | 12-17 |
| 25 | 0 | 10 | 7 |
| 31 | 0 | 10 | 5 |
| 0 | 25 | 8 | 22 |
| 0 | 25 | 10 | 11 |
| 0 | 31 | 10 | 12 |

### Example 6

### Comparative

240 g of a commercially available polyol formulation and 340 g of a commercially available composition of diphenylmethane-4,4′-diisocyanate and isomers and homologues of higher functionality, were mixed by propellers for 20 seconds at 3000 rpm. The material was then transferred into a mold and allowed to foam. The next day, samples measuring 80 mm×30 mm×30 mm was cut and weighed and the density was calculated to 41 kg/m³. Then the sample was placed in a heating cupboard at 200° C. After 24 hours, the foam had shrunk to a length of 56.5 mm and the sample had lost its initial cuboid shape.

### Example 7

240 g of the same commercially available polyol formulation as used in Example 6 was mixed with 480 g ground stone wool fibres with over 50% having a length less than 64 micrometers. The mixture was mixed by propeller for 30 seconds at 3000 rpm. Then 340 g of the commercially available composition of diphenylmethane-4,4′-diisocyanate was added and the mixture was mixed by propellers for 20 seconds at 3000 rpm. The material was then transferred to a mold and allowed to foam. The next day, samples measuring 80 mm×30 mm×30 mm was cut and weighed and the density was calculated to 84 kg/m³. Then the sample was placed in a heating cupboard at 200° C. After 24 hours, the foam had shrunk to a length of 75.5 mm and the sample had maintained its initial cuboid shape.

The cut samples of Examples 6 and 7 are shown in FIG. 4, both before heating and after heating.

FIG. 5 is an environmental scanning electron microscope image of a polyurethane foam composite material as used according to the invention, in which the fibres have a length distribution such that 95% by weight of the fibres have a length below 100 micrometres and 75% by weight of the fibres have a length below 63 micrometres. The composite contains 45% fibres by weight of the composite. The instrument used was ESEM, XL 30 TMP (W), FEI/Philips incl. X-ray microanalysis system EDAX. The sample was analysed in low vacuum and mixed mode (BSE/SE).

The image shows the cellular structure of the foam and demonstrates that the man-made vitreous fibres generally sit in the walls of the cells of the foam without penetrating into the cells themselves to a significant extent.

Coherent Man-Made Vitreous Fibre-Containing Insulating Material

In a preferred embodiment of the invention, there is a covering layer 7 that comprises coherent man-made vitreous fibre-containing insulating material.

The term “coherent” means that the man-made vitreous fibre-containing insulating material is not in the form of a granulate or any other loose insulating material.

The coherent man-made vitreous fibre-containing insulating material is preferably bonded mineral wool, more preferably stone wool. Preferably, the mineral wool consists essentially of binder-coated man-made vitreous fibres.

The man-made vitreous fibres in the coherent man-made vitreous fibre-containing insulating material can be glass fibres, ceramic fibres, slag wool fibres or any other type of man-made vitreous fibre, but they are preferably stone fibres. Stone fibres have a content by weight of oxides as follows:
SiO₂ 25 to 50%, preferably 38 to 48%
Al₂O₃ 12 to 30%, preferably 15 to 28%
TiO₂ up to 2%
Fe₂O₃ 2 to 12%
CaO 5 to 30%, preferably 5 to 18%
MgO up to 15%, preferably 4 to 10%
Na₂O up to 15%
K₂O up to 15%
P₂O₅ up to 3%
MnO up to 3%
B₂O₃ 0 to 3%.

These values are all quoted as oxides, with iron quoted as Fe₂O₃, as is conventional.

The man-made vitreous fibres present in the coherent man-made vitreous fibre-containing insulating material can be produced by standard methods such as with a cascade spinner or a spinning cup. Usually, the fibres are treated with a binder and collected as a web, before being cured. In order to provide a compressible and flexible covering layer, it is preferred that the coherent man-made vitreous fibre-containing insulating material has a density less than 80 kg/m³, more preferably less than 50 kg/m³. Usually the density of the coherent man-made vitreous fibre-containing insulating material is at least 20 kg/m³, more usually at least 30 kg/m³.

It is, of course, relevant for the covering layer 7 to provide a high level of thermal insulation. Therefore, it is preferred that the coherent man-made vitreous fibre-containing insulating material has a thermal conductivity of less than 40 mW/m·K, more preferably less than 35 mW/m·K and most preferably less than 33 mW/m·K.

1. An insulating element for insulating a pipe, comprising:
a partial pipe section having an external convex face, an internal concave face and first and second longitudinal surfaces extending between the external convex face and the internal concave face, the partial pipe section being formed of a polymeric foam composite material comprising a polymeric foam and discontinuous man-made vitreous fibres, wherein at least 50% by weight of the man-made vitreous fibres present in the foam composite material have a length of less than 100 micrometers.

2. An insulating element according to claim 1, wherein a covering layer comprising coherent man-made vitreous fibre-containing insulating material is disposed on the internal concave face and on the first longitudinal surface of the partial pipe section.

3. An insulating element according to claim 2, wherein the coherent man-made vitreous fibre-containing insulating material is mineral wool, preferably stone wool.

4. An insulating element according to claim 2, wherein the covering layer is also disposed on the second longitudinal surface of the partial pipe section.

5. An insulating element according to claim 2, wherein the covering layer and the pipe section are bonded together without any extrinsic attachment means.

6. An insulating element according to claim 1, wherein the insulating element is semi-tubular.

7. An insulating element according to claim 1, wherein at least 60% by weight of the man-made vitreous fibres present in the polymeric foam composite material have a length less than 65 micrometers.

8. An insulating element according to claim 1, wherein at least 80% by weight of the man-made vitreous fibres present in the polymeric foam composite material have a length less than 125 micrometers.

9. An insulating element according to claim 1, wherein at least 95% by weight of the man-made vitreous fibres present in the polymeric foam composite material have a length less than 250 micrometers.

10. An insulating element according to claim 1, wherein the man-made vitreous fibres present in the foam composite material have an average diameter of from 1.5 to 7, preferably 2 to 6, more preferably from 3 to 6 micrometers.

11. An insulating element according to claim 1, wherein the man-made vitreous fibres present in the polymeric foam composite material have a content of oxides as follows:
SiO₂ 25 to 50 wt %, preferably 38 to 48 wt %
Al₂O₃12 to 30 wt %, preferably 15 to 28 wt %, more preferably 17 to 23 wt %
TiO₂ up to 2 wt %
Fe₂O₃ 2 to 12 wt %
CaO 5 to 30 wt %, preferably 5 to 18 wt %
MgO up to 15 wt %, preferably 4 to 10 wt %
Na₂O up to 15 wt %
K₂O up to 15 wt %
P₂O₅ up to 3 wt %
MnO up to 3 wt %
B₂O₃ 0 to 3 wt %.

12. An insulating element according to claim 1, wherein the polymeric foam is a polyurethane foam.

13. An insulating element according to claim 1, wherein the polymeric foam composite material comprises at least 10% by weight, preferably at least 15% by weight, more preferably at least 20% by weight of man-made vitreous fibres.

14. An insulating element according to claim 1, wherein the polymeric foam composite material comprises less than 80% by weight, preferably less than 60%, more preferably less than 55% by weight of man-made vitreous fibres.

15. A method of insulating a pipe, comprising:
providing at least a first insulating element and a second insulating element each as defined in claim 1;
affixing the first and second insulating elements on the pipe to be insulated such that the first and second insulating elements cooperate so as to surround the pipe completely.

16. A method according to claim 15, wherein the first and second insulating elements are each insulating elements in which a covering layer comprising coherent man-made vitreous fibre-containing insulating material is disposed on the internal concave face and on the first longitudinal surface of the partial pipe section and wherein the first and second insulating elements are affixed such that the part of the covering layer disposed on the first longitudinal surface of the first insulating element abuts the second insulating element and such that the part of the covering layer disposed on the first longitudinal surface of the second insulating element abuts the first insulating element, so as to surround the pipe completely.

17. A method according to claim 16, wherein the first and the second insulating elements are each insulating elements in which the covering layer is also disposed on the second longitudinal surface of the partial pipe section, and wherein the insulating elements are affixed on the pipe such that the parts of the covering layer disposed on the first and second longitudinal surfaces of the first insulating element each abut a part of the covering layer disposed on the first or second longitudinal surface of the second insulating element.

18. A pipe that is insulated by first and second insulating elements each as defined in claim 1, wherein the first and second insulating elements cooperate so as to surround the pipe completely.
